(19) United States
(12) Patent Application Publication
(10) Pub. No.: US 2017/0187558 A1
(43) Pub. Date: Jun. 29, 2017

(54) USER APPARATUS, INTERFERENCE DETECTION METHOD, BASE STATION, AND RESOURCE ALLOCATION METHOD

(71) Applicant: NTT DOCOMO, INC., Tokyo (JP)

(72) Inventors: Shimpei Yasukawa, Tokyo (JP); Hiroki Harada, Tokyo (JP); Yongbo Zeng, Beijing (CN); Qun Zhao, Beijing (CN); Yongsheng Zhang, Beijing (CN)

(73) Assignee: NTT DOCOMO, INC., Tokyo (JP)

(21) Appl. No.: 15/308,783

(22) PCT Filed: Apr. 7, 2015
(86) PCT No.: PCT/JP2015/060880

§ 371 Date: Nov. 3, 2016

(30) Foreign Application Priority Data
May 9, 2014 (JP) 2014-098134

(51) Int. Cl. H04L 27/26; H04W 92/18; H04B 1/10; H04W 72/12; H04J 11/00; H04W 72/08

(52) U.S. Cl. CPC H04L 27/2607; H04J 11/0033; H04L 27/2678; H04W 72/082; H04B 1/10; H04L 27/2675; H04W 72/12; H04W 92/18; H04J 2211/005

(57) ABSTRACT

A user apparatus is provided. The user apparatus includes a cyclic prefix length detection unit configured to detect a cyclic prefix length used by a user apparatus of a neighbor cell or out of coverage; and an interference detection unit configured to detect interference caused by a cyclic prefix length difference, a synchronization timing difference, or collision of resources used for signal transmission. Further, a base station is provided. The base station includes a reception unit configured to receive from a user apparatus an interference result caused by a cyclic prefix length difference; a resource allocation unit configured to set resources based on the received interference result; and a transmission unit configured to transmit the set resource information to the user apparatus.

### BACKGROUND OF THE INVENTION

1. Field of the Invention

The present invention relates to a user apparatus, an interference detection method, a base station, and a resource allocation method.

2. Description of the Related Art

Currently, specifications enhancing functionality of LTE-Advanced are under development as a new generation of communication standards of long term evolution (LTE) in the 3rd Generation Partnership Project (3GPP).

In an LTE system or an LTE-Advanced system, as a radio access method, orthogonal frequency division multiple access (OFDMA) is used for downlink, which OFDMA provides high resistance to multipath interference and is capable of flexibly corresponding to a wide range of frequency bandwidth by changing the number of subcarriers. Further, single carrier-frequency division multiple access (SC-FDMA) is used for uplink, which SC-FDMA is capable of providing reduced energy consumption by reducing a peak-to-average power ratio (PAPR) of a terminal (hereinafter, referred to as a user apparatus UE), and providing reduced interference by orthogonalization of signals between user apparatuses UE.

In orthogonal frequency division multiplexing (OFDM), symbol interference in which delayed waves of the previous symbol interfere with the following OFDM symbol, and interference between subcarriers caused by collapsed orthogonality between subcarriers, are removed by providing a guard space called cyclic prefix (CP) at the head of each OFDM symbol,

### CITATION LIST

### Non-Patent Literature

[Non-Patent Literature 1] 3GPP TR 36.843 V12.0.1 (2014-03)

### SUMMARY OF THE INVENTION

### Technical Problem

In mobile communications, it is common that the communications between user apparatuses UE are performed by having communications between a user apparatus UE and a base station eNB. Recently, various technologies have been studied on direct communications between the user apparatuses UE (refer to Non-Patent Literature 1). Direct communications between user apparatuses UE are referred to as device to device (D2D) communications or inter-user apparatus communications.

The D2D communications include, not only D2D communications performed between user apparatuses UE within the same cell, but also D2D communications performed between user apparatuses of different cells and D2D communications performed between an in-coverage user apparatus UE and an out-of-coverage user apparatus UE.

The user apparatus UE uses a CP length indicated by upper layer signaling such as a system information block (SIB), etc., from the base station eNB. In general, there are two kinds of CP lengths (normal CP and extended CP) used in the mobile communications. In addition to the above CP lengths, a CP length longer than the extended CP may be defined and used in the D2D communications. Between the user apparatuses UE in the same cell, the same CP length indicated by the base station eNB is used. However, between the user apparatuses UE of different cells, or between the user apparatuses UE in and out of coverage, there is a possibility that different CP lengths are used.

FIG. 1A illustrates an example in which different CP lengths are used between different cells. User apparatuses UE1 and UE2 use a CP length indicated by a SIB from a base station eNB1 of own cell, and user apparatus UE3 uses a CP length indicated by a SIB from a base station eNB2 of own cell. In the case where the normal CP is indicated by a SIB from the base station eNB1 and the extended CP is indicated by a SIB from the base station eNB2, the user apparatus UE1 receives from the user apparatus UE2 a D2D signal which uses the normal CP and receives from the user apparatus UE3 a D2D signal which uses the extended CP.

As described above, in the case where D2D signals (including a discovery signal, scheduling information (scheduling assignment (SA)), etc.,), in which different CP lengths are set between different cells, are transmitted at the same time, D2D signal interference occurs, and D2D signal reception performance of the user apparatus UE1 is degraded.

Further, FIG. 1B illustrates an example in which different CP lengths are used between in-coverage and out-of-coverage user apparatuses. The user apparatuses UE1 and UE2 use a CP length indicated by a SIB from the base station eNB1 of own cell, and the user apparatus UE3 uses a CP length indicated by a user apparatus SS-UE which transmits an out-of-coverage synchronization signal, a CP length set by own determination, or a predefined CP length. In the case where the normal CP is indicated by the base station eNB1 and the extended CP is indicated by the user apparatus SS-UE, the user apparatus UE1 receives from the user apparatus UE2 a D2D signal which uses the normal CP and receives from the user apparatus UE3 a D2D signal which uses the extended CP.

As described above, in the case where D2D signals (including a discovery signal, schedule information (scheduling assignment (SA)), etc.,), in which different CP lengths are set between different cells, are transmitted at the same time, D2D signal interference occurs.

FIG. 2 is a drawing illustrating interference caused by a CP length difference. The user apparatus UE2 transmits a D2D signal which uses the normal CP, and, the user apparatus UE3 transmits a D2D signal which uses the extended CP. Even if these D2D signals are transmitted via different resource blocks (RB), in the case where the user apparatus UE1 performs receiving a D2D signal from the user apparatus UE2 by using a fast Fourier transform (FFT) window in accordance with the normal CP, a D2D signal from the user apparatus UE3 serves as interference due to a CP length difference. In addition to the case where the CP lengths are different, the interference also occurs in the case where the D2D signals are not synchronized.

An object of the present invention is to detect interference including the CP length difference, and reduce or avoid the interference.

### Solution to Problem

According to an embodiment, a user apparatus is provided. The user apparatus includes a cyclic prefix length detection unit configured to detect a cyclic prefix length used by a user apparatus of a neighbor cell or out of coverage; and an interference detection unit configured to detect interference caused by a cyclic prefix length difference, a synchronization timing difference, or collision of resources used for signal transmission.

Further, according to an embodiment, an interference detection method in a user apparatus is provided. The interference detection method includes detecting a cyclic prefix length used by a user apparatus of a neighbor cell or out of coverage; and detecting interference caused by a cyclic prefix length difference, a synchronization timing difference, or collision of resources used for signal transmission.

Further, according to an embodiment, a base station is provided. The base station includes a reception unit configured to receive from a user apparatus an interference result caused by a cyclic prefix length difference; a resource allocation unit configure to set resources based on the received interference result; and a transmission unit configured to transmit the set resource information to the user apparatus.

Further, according to an embodiment, a resource allocation method in a base station is provided. The resource allocation method includes receiving from a user apparatus an interference result caused by a cyclic prefix length difference; setting resources based on the received interference result; and transmitting the set resource information to the user apparatus.

### Advantageous Effects of Invention

According to an embodiment of the present invention, it is possible to detect interference including a CP length difference, and reduce or avoid the interference.

### BRIEF DESCRIPTION OF THE DRAWINGS

FIG. 1A illustrates an example in which different CP lengths are used between different cells.

FIG. 1B illustrates an example in which different CP lengths are used between in-coverage and out-of-coverage user apparatuses.

FIG. 2 is a drawing illustrating interference caused by a CP length difference.

FIG. 3 is a drawing illustrating a configuration diagram of a communication system according to an embodiment of the present invention (No. 1).

FIG. 4 is a drawing illustrating a configuration diagram of a communication system according to an embodiment of the present invention (No. 2).

FIG. 5A is a drawing illustrating an example of D2DSS symbol positions used for reporting a CP length (an example using a D2DSS symbol interval).

FIG. 5B is a drawing illustrating an example of D2DSS symbol positions used for reporting a CP length (an example using D2DSS symbol positions).

FIG. 5C is a drawing illustrating an example of D2DSS symbol positions used for reporting a CP length (an example using D2DSS symbol positions).

FIG. 6 is a drawing illustrating an example of D2DSS parameters used for reporting a CP length.

FIG. 7 is a drawing illustrating a configuration diagram of a base station according to an embodiment.

FIG. 8 is a drawing illustrating a configuration diagram of a baseband signal processing unit in a base station according to an embodiment.

FIG. 9 is a drawing illustrating a configuration diagram of a user apparatus according to an embodiment.

FIG. 10 is a drawing illustrating a configuration diagram of a baseband signal processing unit in a user apparatus according to an embodiment.

FIG. 11 is a flowchart illustrating an interference detection method in a user apparatus according to a first embodiment.

FIG. 12A is a drawing illustrating overlapping of resources detected in a user apparatus according to an embodiment (interference type 1).

FIG. 12B is a drawing illustrating overlapping of resources detected in a user apparatus according to an embodiment (interference type 2).

FIG. 13 is a drawing illustrating an example of an effective use of overlapping of resources detected in a user apparatus according to an embodiment (interference type 2).

FIG. 14 is a flowchart illustrating an interference avoiding method in a user apparatus according to a second embodiment.

FIG. 15 is a drawing illustrating an example of reporting contents by a user apparatus according to an embodiment.

FIG. 16A is an example of resources allocated by a base station according to an embodiment (an example in which different resources are allocated between different cells).

FIG. 16B is an example of resources allocated by a base station according to an embodiment (an example in which the same resources are allocated between different cells).

FIG. 17 is a flowchart illustrating an interference avoiding method in a user apparatus according to a third embodiment.

FIG. 18 is a flowchart illustrating an interference avoiding method in a base station according to the third embodiment.

FIG. 19 is sequence diagram illustrating an interference avoiding method in a communication system according to a fourth embodiment.

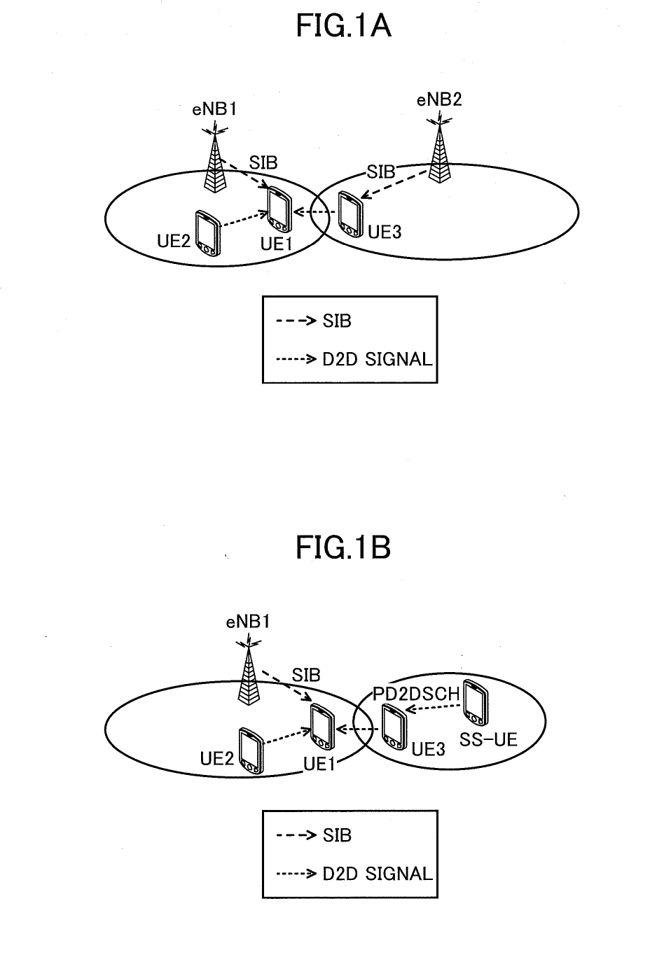

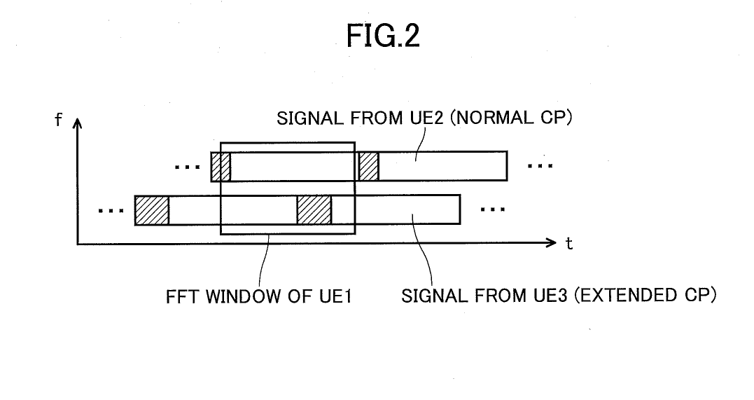

### DETAILED DESCRIPTION OF THE PREFERRED EMBODIMENTS

In the following, an embodiment of the present invention will be described referring to the drawings.

<Overview of Communication System>

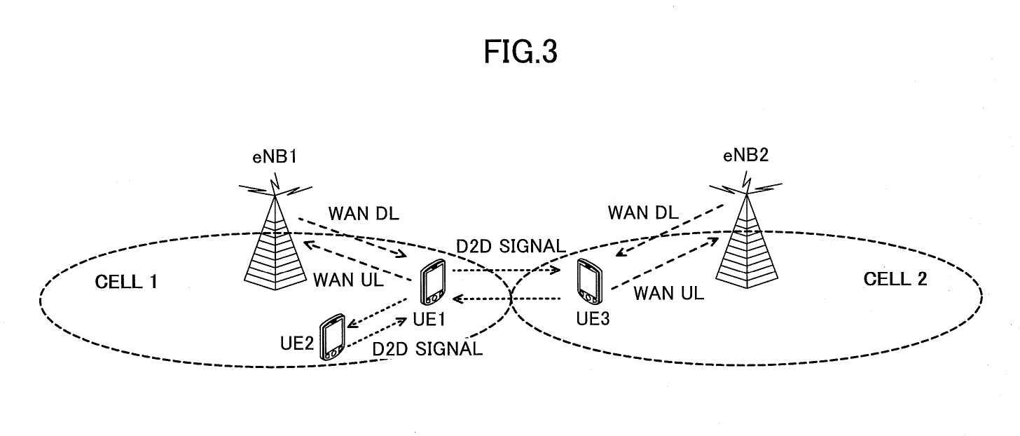

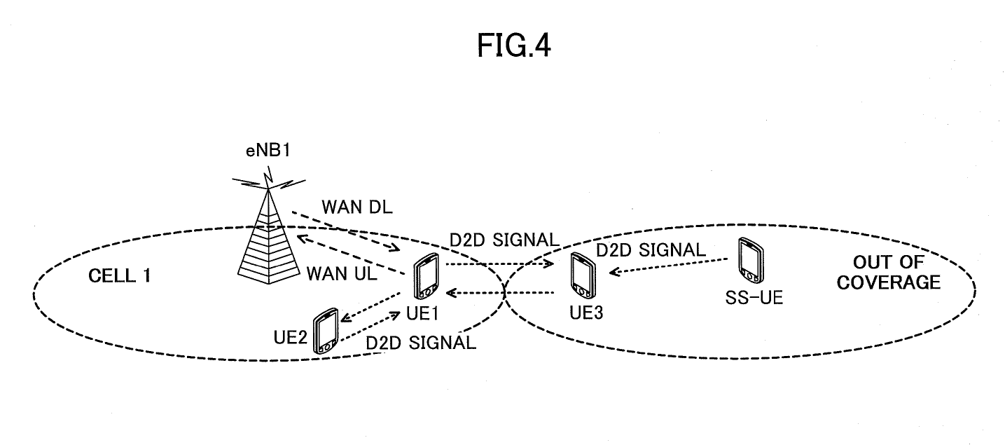

FIG. 3 is a configuration diagram of a communication system according to an embodiment. The communication system according to an embodiment is a cellular communication system in which a plurality of user apparatuses UE exist under a base station eNB. There are a plurality of base stations eNB and a plurality of user apparatuses UE in the communication system. Of all the base stations eNB and user apparatuses UE, only two base stations eNB1 and eNB2, and three user apparatuses UE1, UE2, and UE3 are shown in FIG. 3. A user apparatus UE which performs D2D communications may also exist out of cell (out of coverage). Regarding a case where a user apparatus UE exists out of coverage, the case will be described below by referring to FIG. 4.

The base station eNB1 communicates with the user apparatuses UE1 and UE2 in a cell 1 of the base station eNB1 by using resources of cellular communications (hereinafter, referred to as WAN). Similarly, the base station eNB2 communicates with the user apparatus UE3 in a cell 2 of the base station eNB2 by using WAN resources. The user apparatus UE1 can directly communicate with the user apparatuses UE2 and UE3 by using resources for D2D communications without going through base stations eNB1 and eNB2. The WAN resources and the D2D communication resources are multiplexed by using frequency division multiplexing (FDM), time division multiplexing (TDM), a combination of TDM and FDM, etc.

The base station eNB1 of the cell 1 reports to the user apparatuses UE1 and UE2 under the base station eNB1 a CP length used for signal transmission by using upper layer signaling such as a system information block (SIB), etc. Similarly, the base station eNB2 of the cell 2 reports to the user apparatus UE3 under the base station eNB2 a CP length used for signal transmission by using upper layer signaling such as a system information block (SIB), etc. Here, it is assumed that two types of CP lengths (a normal CP and an extended CP) will be used. The number of the CP length types may be equal to or more than two.

The user apparatuses UE1, UE2, and UE3 transmit a D2D signal (including a synchronization signal, a discovery signal, scheduling assignment (SA), data, etc.,) by using corresponding CP lengths reported by the base stations eNB1 and eNB2.

In the case where different CP lengths are reported by the base station eNB1 and the base station eNB2, there is a possibility that D2D signals in which different CP lengths are set between the cells are transmitted at the same time. For example, in the case where the user apparatus UE2 transmits a D2D signal by using the normal CP, and at the same time, the user apparatus UE3 transmits a D2D signal by using the extended CP, the D2D signals interfere each other, and D2D signal reception performance of the user apparatus UE1 is degraded.

FIG. 4 illustrates a case where the user apparatus UE3 exists out of coverage. The user apparatus UE3 which exists out of coverage may set a CP length reported by the user apparatus SS-UE which transmits a D2DSS, may set a CP length based on own determination, or may set a fixed CP length in some of D2D signals.

The user apparatuses UE1 and UE2 transmit D2D signals (including a discovery signal, scheduling assignment (SA), etc.,) by using a CP length reported by the base station eNB1, and the user apparatus UE3 transmits D2D signals by using a CP length reported by the user apparatus SS-UE, by using a CP length based on own determination, or by using a fixed CP length in some of D2D signals.

Similarly, in the this case, there is a possibility that D2D signals in which different CP lengths are set between the cells are transmitted at the same time. For example, in the case where the user apparatus UE2 transmits a D2D signal by using the normal CP, and at the same time, the user apparatus UE3 transmits a D2D signal by using the extended CP, the D2D signals interfere with each other, and D2D signal reception performance of the user apparatus UE1 is degraded.

Therefore, according to an embodiment, by using the following methods, interference will be detected and the interference will be reduced or avoided.

(First embodiment) Detection of a CP length used by a user apparatus of a neighbor cell or out of coverage (D2DSS correlation based detection, detection based on D2DSS parameters, and detection based on reception of a SIB of a neighbor cell)

(Second embodiment) stopping transmission in some of resources in which interference is detected

(Third embodiment) reporting an interference result to a base station and re-allocating resources by the base station

(Fourth embodiment) reporting a CP length to a user apparatus out of coverage

These methods will be described below in detail.

### First Embodiment

In a first embodiment, a method of detecting a CP length used by a user apparatus of a neighbor cell or out of coverage will be described.

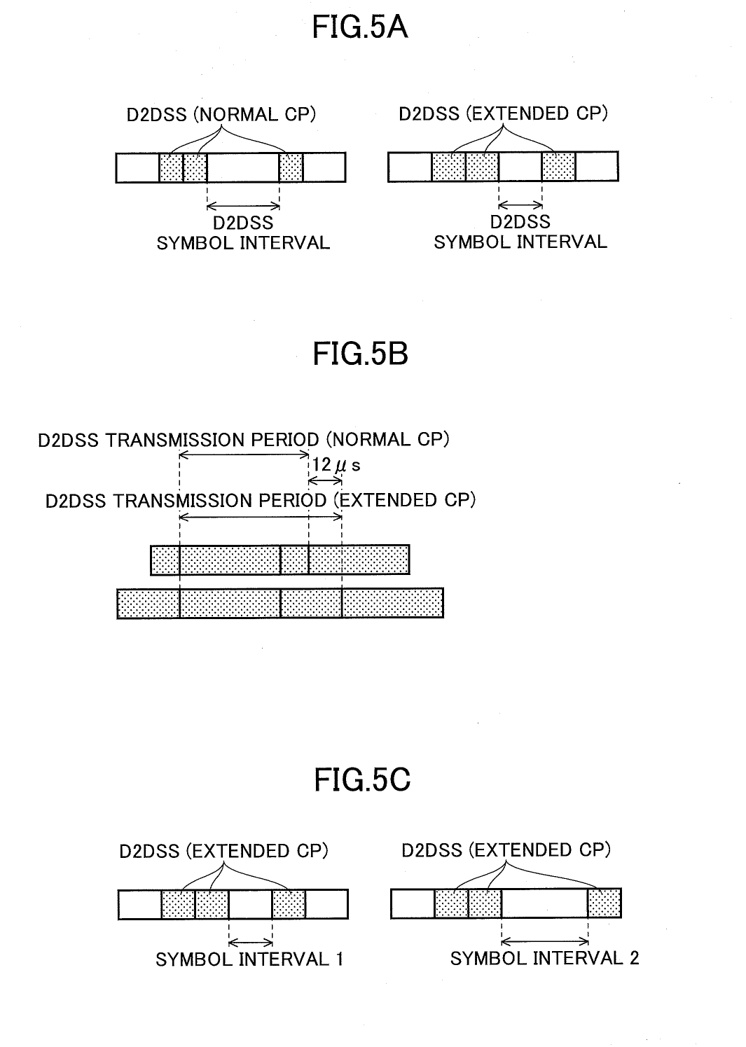

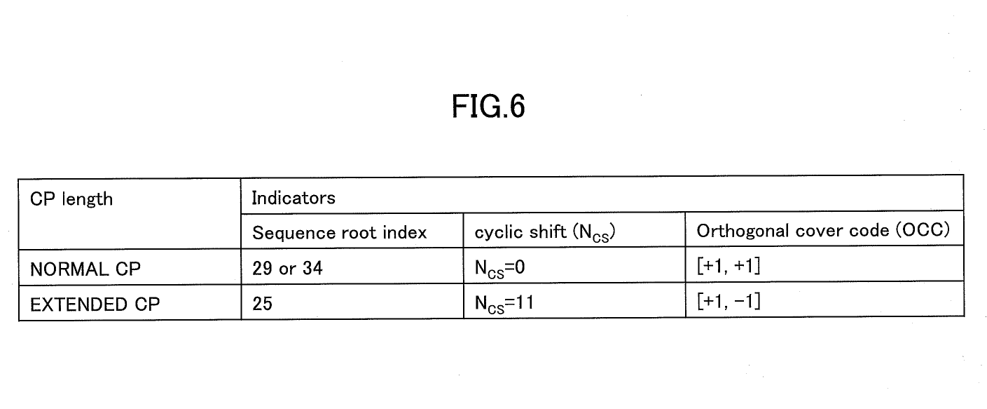

In order to detect a CP length, a device to device synchronization signal (D2DSS) may be used. The D2DSS is a synchronization signal used by user apparatuses for matching transmission and reception timing. For example, referring to FIGS. 5A through 5C and FIG. 6, the user apparatus UE1 or UE3 illustrated in FIG. 3 or FIG. 4 which is located at the edge of a cell may transmit a D2DSS as described below.

FIGS. 5A through 5C are examples of D2DSS symbol positions used for reporting a CP length. In the case where a D2DSS CP length is the same as a CP length of SA and/or a discovery signal, as illustrated in FIG. 5A, the D2DSSs may be arranged at multiple symbol positions in a slot. For example, in the case where D2DSS symbols are arranged at predetermined symbol positions with an interval, a D2DSS symbol interval in the case of normal CP is greater than a D2DSS symbol interval in the case of extended CP. It is possible for the user apparatuses UE1 and UE3 to detect a CP length based on the D2DSS symbol interval. More specifically, the user apparatus UE1 or UE3 detects a D2DSS according to correlation based detection. In the case where the detected D2DSS symbol interval is greater than a predetermined threshold value, it is possible for the user apparatus UE1 or UE3 to determine that the normal CP is used in a neighbor cell. On the other hand, in the case where the detected D2DSS symbol interval is less than the predetermined threshold value, it is possible for the user apparatus UE1 or UE3 to determine that the extended CP is used in the neighbor cell.

Further, as illustrated in FIG. 5B, the D2DSSs may be arranged at two consecutive symbol positions. Symbol transmission intervals are different due to a CP length difference. Therefore, it is possible for the user apparatus UE1 or UE3 to detect a CP length by performing correlation based detection by assuming two types of CP lengths (e.g., a D2DSS transmission interval for the normal CP, and a D2DSS transmission interval for the extended CP (the D2DSS transmission interval for the normal CP+12 μs)).

Further, as illustrated in FIG. 5C, in the case where a D2DSS CP length is different from a CP length of SA and/or a discovery signal, it is possible to detect a CP length of SA and/or a discovery signal by fixing the D2DSS CP length and changing symbol positions at which D2DSSs are arranged. For example, if the extended CP is used for D2DSS, then different D2DSS symbol intervals are used according to a CP length of SA and/or a discovery signal. In the case of the extended CP, a symbol interval 1 is used, and in the case of the normal CP, a symbol interval 2 is used. It is possible for the user apparatus UE1 or UE3 to detect a CP length according to the D2DSS symbol positions. More specifically, the user apparatus UE1 or UE3 detects a D2DSS according to correlation based detection. In the case where the detected D2DSS symbol interval is the symbol interval 1, it is possible for the user apparatus UE1 or UE3 to determine that the extended CP is used in a neighbor cell.

Further, the CP length may be reported by changing D2DSS parameters. FIG. 6 is a drawing illustrating an example of D2DSS parameters used for reporting the CP length. Different D2DSS sequence root indexes, cyclic shifts (NCS), orthogonal cover codes (OCC), etc., may be used according to the CP length.

For example, in the case where at least two types of D2DSS sequence root indexes are prepared, the sequence root indexes may be used for reporting the CP length. For example, at least one sequence root index (e.g., 29 or 34) may be used for the normal CP, and another sequence root index (e.g., 25) may be used for the extended CP.

For example, in the case where one type of D2DSS sequence root index is prepared, cyclic shifts of the sequence root index may be used for reporting the CP length. For example, at least one cyclic shift (e.g., NCS=0) may be used for the normal CP, and another cyclic shift (e.g., NCS=11) may be used for the extended CP.

For example, in the case where one type of D2DSS sequence root index is prepared, orthogonal cover codes may be used for reporting the CP length. For example, at least one orthogonal cover code ([+1, +1]) may be used for the normal CP, and another orthogonal cover code ([+1, −1]) may be used for the extended CP. It should be noted that, in this case, it is necessary for D2DSSs to be arranged at at least two symbols.

As described above, even in the case where the CP length is reported by the D2DSS parameter difference, it is possible for the user apparatus UE1 or UE 3 to detect the CP length by performing D2DSS correlation based detection.

<Base Station Configuration>

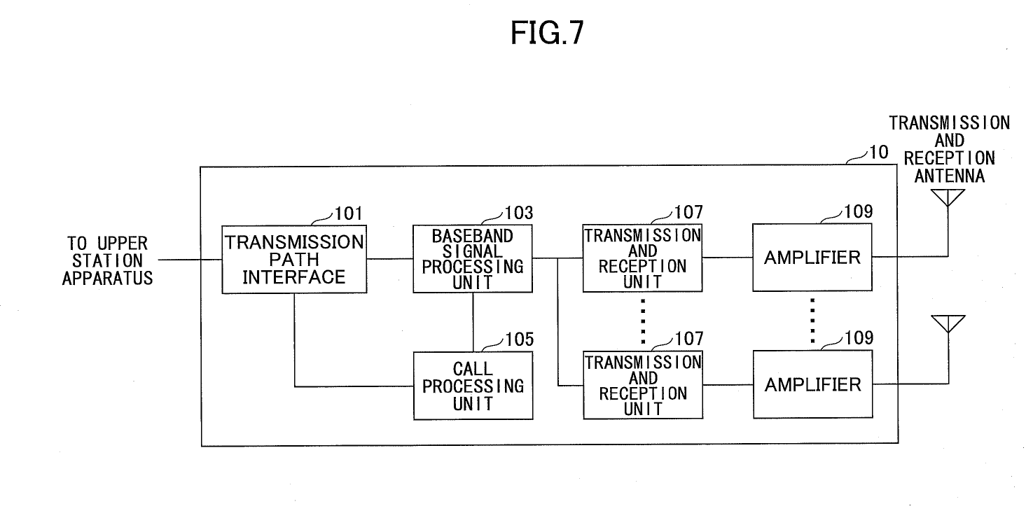

FIG. 7 is a configuration diagram of a base station (eNB) 10 according to an embodiment. The base station 10 includes a transmission path interface 101, a baseband signal processing unit 103, a call processing unit 105, a transmission and reception unit 107, and an amplifier 109.

Data to be transmitted from the base station 10 to the user apparatus via downlink is input to the baseband signal processing unit 103 from an upper station apparatus via the transmission path interface 101.

In the baseband signal processing unit 103, packet data convergence protocol (PDCP) layer processing, radio link control (RLC) layer transmission processing including dividing/combining data and RLC retransmission control transmission processing, transmission processing of medium access control (MAC) retransmission control such as hybrid automatic repeat request (HARQ) transmission processing, scheduling, transmission format selection, channel coding, inverse fast Fourier transform (IFFT) processing, and precoding processing are performed. Further, regarding a signal of a physical downlink control channel as a downlink control channel, transmission processing including channel coding, IFFT processing, etc., is performed.

The call processing unit 105 performs call processing such as setting and releasing communication channels, status management of the base station 10, and radio resource management.

The transmission and reception unit 107 performs converting the frequency of a baseband signal output from the baseband signal processing unit 103 to the radio frequency band. The amplifier 109 amplifies the frequency-converted transmission signal and outputs the amplified signal to a transmission and reception antenna. It should be noted that, in the case where multiple transmission and reception antennas are used, there may be multiple transmission and reception units 107 and amplifiers 109.

On the other hand, regarding a signal transmitted from the user apparatus to the base station 10 via uplink, the radio frequency signal received by the transmission and reception antenna is amplified by the amplifier 108, and the amplified signal is frequency-converted to a baseband signal by the transmission and reception unit 107, and input to the baseband signal processing unit 103.

The baseband signal processing unit 103 performs FFT processing, IDFT processing, error correction decoding, MAC retransmission control reception processing, and RLC layer/PDCP layer reception processing for data included in the baseband signal received via uplink. The decoded signal is transferred to the upper station apparatus via the transmission path interface 101.

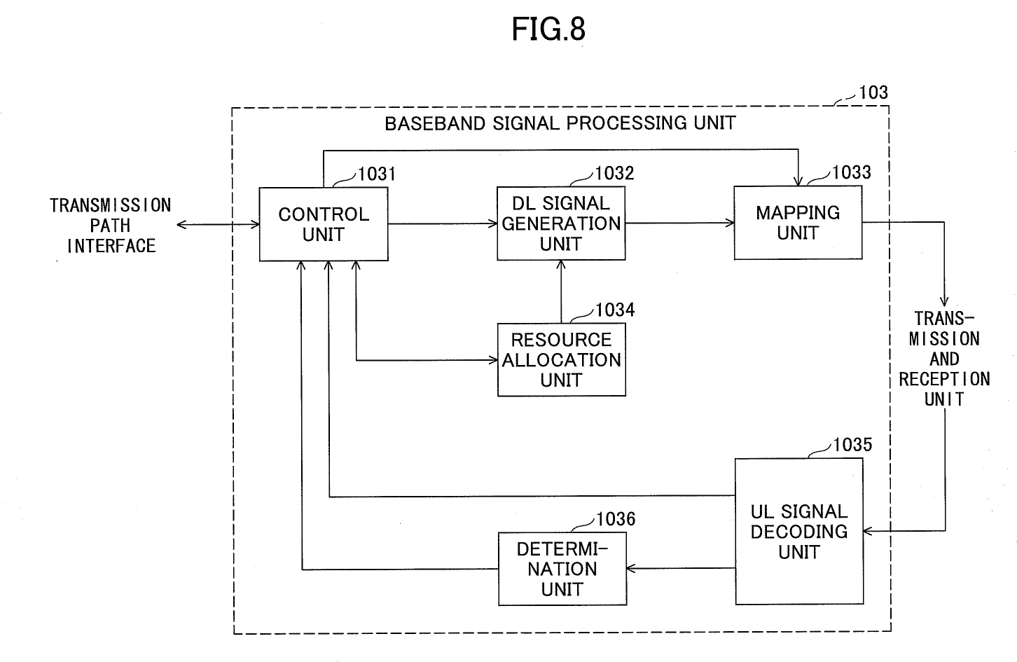

FIG. 8 is a drawing illustrating a configuration diagram of a baseband signal processing unit 103 in the base station 10 according to an embodiment. The baseband signal processing unit 103 includes a control unit 1031, downlink (DL) signal generation unit 1032, a mapping unit 1033, a resource allocation unit 1034, an uplink (UL) signal decoding unit 1035 and a determination unit 1036.

The control unit 1031 performs overall management of the baseband signal processing unit 103. Regarding a signal to be transmitted to the user apparatus via downlink, the data input from the transmission path interface 101 is input to the DL signal generation unit 1032. Regarding a signal received from the user apparatus via uplink, the data decoded by the UL signal decoding unit 1035 is input to the transmission path interface 101.

The DL signal generation unit 1032 generates a signal to be transmitted to the user apparatus. The signal to be transmitted to the user apparatus includes data and control information. The data is transmitted by mainly a physical downlink shared channel (PDSCH), and allocation information needed for receiving the PDSCH is transmitted by a physical downlink control channel (PDCCH) or by an enhanced PDCCH (ePDCCH). Further, the DL signal generation unit 1032 generates a system information block (SIB) used for reporting the CP length.

The mapping unit 1033 maps data to be transmitted via a PDSCH and control information to be transmitted via a PDCCH or an ePDCCH to resources determined by the scheduling unit (not shown).

The resource allocation unit 1034 allocates WAN resources or D2D communication resources (including resources of D2DSS, SA, and a discovery signal) to the user apparatus. Further, the resource allocation unit 1034 re-allocates the resources when an interference result caused by a CP length difference is received from the user apparatus. Regarding an operation of the resource allocation unit 1034 in the case where there exist different CP lengths, the operation will be described in detail in the following third embodiment.

The UL signal decoding unit 1035 decodes a signal received from the user apparatus via uplink. Data received via a physical uplink shared channel (PUSCH) is input to the control unit 1031 to be provided to the transmission path interface 101, and transmission acknowledgment information (ACK/NACK) received via a PUCCH is also input to the control unit 1031 for retransmission processing such as HARQ.

The determination unit 1036 performs retransmission determination of a signal received via a PUSCH. In the case of successful PUSCH reception, transmission acknowledgment information indicating no need for retransmission (ACK) is generated, and in the case of PUSCH reception failure, transmission acknowledgment information indicating need for retransmission (NACK) is generated.

<Configuration and Operation of User Apparatus>

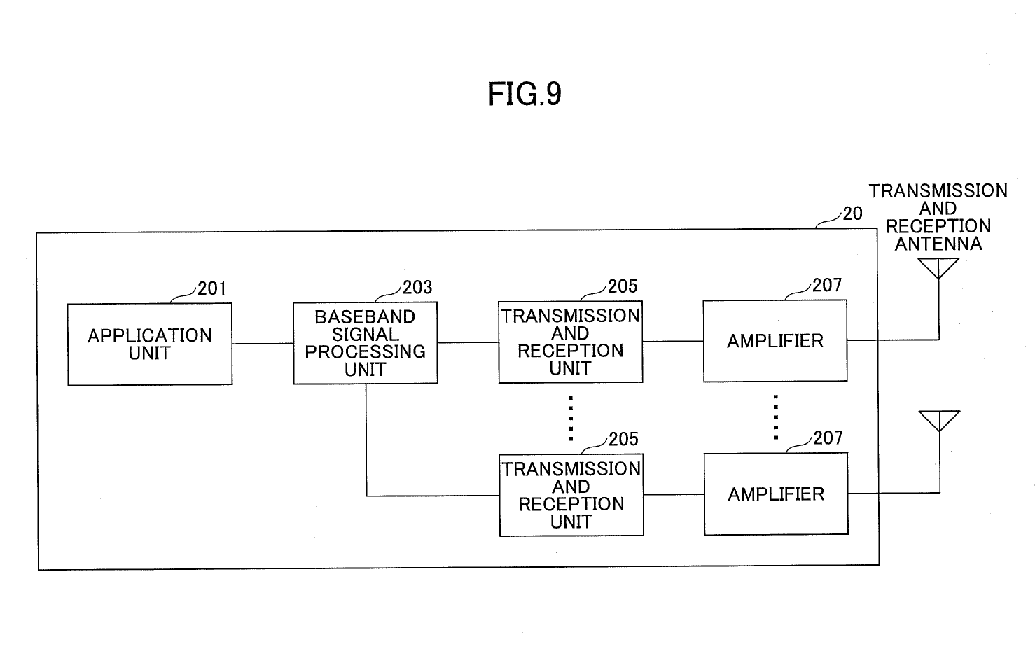

FIG. 9 is a configuration diagram of a user apparatus 20 according to an embodiment. The user apparatus 20 includes an application unit 201, a baseband signal processing unit 203, a transmission and reception unit 205, and an amplifier 207.

Regarding downlink data, the radio frequency signal received by a transmission and reception antenna is amplified by the amplifier 207, and frequency-converted to a baseband signal by the transmission and reception unit 205. FFT processing, error correction decoding, reception processing of retransmission control, etc., are applied to the baseband signal by the baseband signal processing unit 203. The downlink data is transferred to the application unit 201. The application unit 201 performs processing related to the layers upper than the physical layer or the MAC layer.

On the other hand, uplink data is input from the application unit 201 to the baseband signal processing unit 203. Transmission processing of retransmission control, channel coding, DFT processing, and IFFT processing are performed by the baseband signal processing unit 203. The transmission and reception unit 205 converts a baseband signal output from the baseband signal processing unit 203 to a radio frequency signal. Afterwards, the radio frequency signal is amplified by the amplifier 207 and transmitted from the transmission and reception antenna.

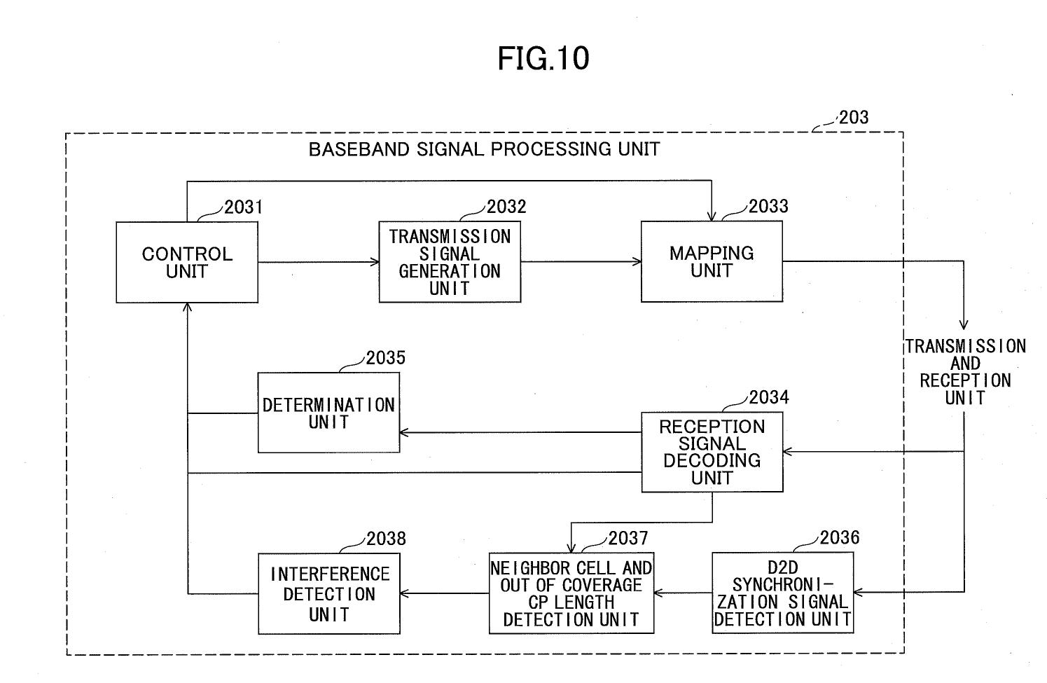

FIG. 10 is a drawing illustrating a configuration diagram of a baseband signal processing unit 203 in the user apparatus 20 according to an embodiment. The baseband signal processing unit 203 includes a control unit 2031, a transmission signal generation unit 2032, a mapping unit 2033, a reception signal decoding unit 2034, a determination unit 2035, a D2D synchronization signal detection unit 2036, a neighbor cell and out of coverage CP length detection unit 2037, and an interference detection unit 2038. In FIG. 10, one reception signal decoding unit 2034 and one determination unit 2035 are shown. However, the baseband signal processing unit 203 may include reception signal decoding units 2034 and determination units 2035 corresponding to WAN communications and D2D communications, respectively.

The control unit 2031 performs overall management of the baseband signal processing unit 203. Regarding a signal to be transmitted to the base station via uplink, the data input from the application unit 201 is input to the transmission signal generation unit 2032. Regarding a signal received from the base station via downlink, the data to which reception processing is applied by the reception signal decoding unit 2034 is input to the application unit 201. Further, the control unit 2031 performs stopping transmission, changing D2D signal mapping, reporting the CP length to the user apparatus out of coverage, etc., in the case where an interference result is detected caused by a CP length difference, a synchronization timing difference, or D2D signal time/frequency resource collision. Regarding an operation of the control unit 2031 in the case where there exist different CP lengths, the operation will be described in detail in the following second through fourth embodiments.

The transmission signal generation unit 2032 generates a signal to be transmitted to the base station or other user apparatuses. The signal to be transmitted to the base station includes data and control information, and the data will be transmitted mainly via a PUSCH. Further, transmission acknowledgment information (ACK/NACK) of the data received from the base station via a PDSCH is transmitted via a PUCCH. The signal to be transmitted to the base station is transmitted by using WAN resources. The signal to be transmitted to other user apparatuses includes D2DSS, SA, a discovery signal, and D2D data. The D2DSS, SA and the discovery signal, of the signals to be transmitted to other user apparatuses, are transmitted by using a transmission resource pool for D2D communications reported by the base station. The D2D data of the signal to be transmitted to other user apparatuses may be transmitted in the resource pool for the D2D data communications, or may be transmitted by using WAN resources.

The mapping unit 2033 maps the data to be transmitted via a PUSCH to the resources determined by the scheduling unit of the base station. Further, the mapping unit 2033 sets the D2DSS, SA, and a discovery signal to be transmitted to other user apparatuses in the transmission resource pool reported by the base station. Further, the mapping unit 2033 maps the D2D data to be transmitted to other user apparatuses to allocated positions of resources indicated by the SA.

The reception signal decoding unit 2034 decodes a signal received from the base station via downlink. The data received via a PDSCH is input to the control unit 2031 to be provided to the application unit 201. The signal received from the base station by the reception signal decoding unit 2034 includes a system information block (SIB) indicating the CP length. Further, the reception signal decoding unit 2034 decodes a signal received from other user apparatuses. The data included in the decoded signal is input to the control unit 2031 to be provided to the application unit 201. The signal received from other user apparatuses by the reception signal decoding unit 2034 includes SA, a discovery signal, and D2D data. In the case of receiving a signal from other user apparatuses, the reception signal decoding unit 2034 may use synchronization information detected by the D2D synchronization signal detection unit 2036 and the CP length detected by the neighbor cell and out of coverage CP length detection unit 2037 or the CP length received by the reception signal decoding unit 2034 from the base station.

The determination unit 2035 performs retransmission determination of a signal received via a PDSCH. In the case of successful PDSCH reception, transmission acknowledgment information indicating no need for retransmission (ACK) is generated, and in the case of PDSCH reception failure, transmission acknowledgment information indicating need for retransmission (NACK) is generated. Further, the determination unit 2035 performs retransmission determination of the received D2D signal. In the case of successful D2D signal reception, transmission acknowledgment information indicating no need for retransmission (ACK) is generated, and in the case of D2D signal reception failure, transmission acknowledgment information indicating need for retransmission (NACK) is generated.

The D2D synchronization signal detection unit 2036 detects D2DSS transmitted from other user apparatuses. Because a predetermined signal sequence is used for D2DSS, it is possible for the D2D synchronization signal detection unit 2036 to detect a synchronization signal by correlation based detection, etc.

The neighbor cell and out of coverage CP length detection unit 2037 detects the CP length used by a user apparatus of a neighbor cell or out of coverage. The CP length may be detected by D2DSS correlation based detection or D2DSS parameters detection, and may be detected by receiving a SIB of a neighbor cell. A time window for searching D2DSS may be set by the base station.

The interference detection unit 2038 detects interference caused by a CP length difference, a synchronization timing difference, or a collision of time/frequency resources of D2D signals. The interference detection unit 2038 may detect occurrence of interference in the case where signal reception has failed in specific resources and the received energy of the resources is greater than a threshold value. Further, the interference detection unit 2038 may detect, from information of a transmission resource pool used by other cells, a possibility of occurrence of interference due to collision of time/frequency resources of D2D signals. As described above, it is possible for the neighbor cell and out of coverage CP length detection unit 2037 to determine whether the same or different CP length is used by a user apparatus of a neighbor cell or out of coverage. In the case where occurrence of interference is detected and a different CP length is used by a user apparatus of a neighbor cell or out of coverage, the interference detection unit 2038 detects the occurrence of interference caused by a CP length difference (interference type 1). Further, in the case where occurrence of interference is detected and the same CP length is used by a user apparatus of a neighbor cell or out of coverage, the interference detection unit 2038 detects the occurrence of interference caused by a synchronization timing difference between cells (interference type 2).

An interference result detected by the interference detection unit 2038 may be input to the control unit 2031, and a signal to be transmitted to the base station may be generated from the interference result by the transmission signal generation unit 2032. It should be noted that the interference result may be reported to the base station by a user apparatus in a connected state (RRC_Connected).

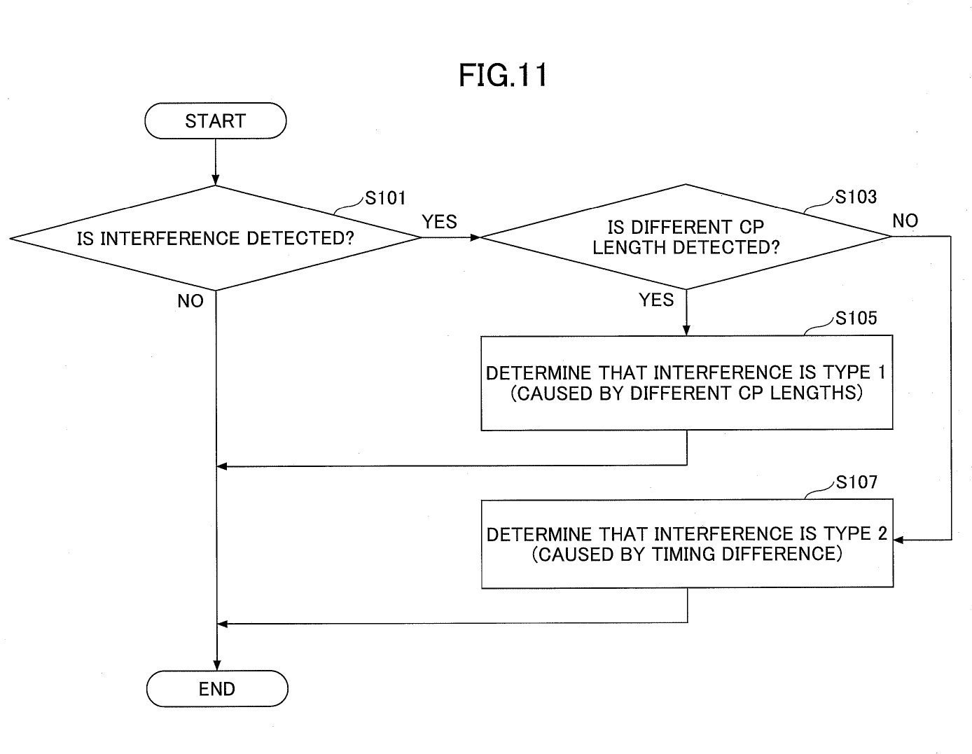

FIG. 11 is a flowchart illustrating an interference detection method in a user apparatus according to a first embodiment.

The interference detection unit 2038 of the user apparatus 20 detects interference by, for example, failing signal reception in specific resources and determining whether the received energy in the resources is greater than a threshold value (step S101). Further, the interference detection unit 2038 may detect, from information of a transmission resource pool used by other cells, a possibility of occurrence of interference.

The neighbor cell and out of coverage CP length detection unit 2037 detects whether a different CP length is used by a user apparatus of a neighbor cell or out of coverage (step S103). As described above, the CP length used by a user apparatus which exists in a neighbor cell or out of coverage may be detected by D2DSS correlation based detection or D2DSS parameters detection, or may be detected by reception of a SIB of a neighbor cell.

In the case where interference is detected by the interference detection unit 2038 and a different CP length is used by a user apparatus of a neighbor cell or out of coverage (step S103: YES), the interference detection unit 2038 determines that the interference is of interference type 1 (interference caused by a CP length difference) (step S105). Further, in the case where interference has occurred and the same CP length is used by a user apparatus of a neighbor cell or out of coverage (step S103: NO), the interference detection unit 2038 determines that the interference is of interference type 2 (interference caused by a synchronization timing difference) (step S107). An interference result detected by the interference detection unit 2038 may be reported to the base station.

As described above, according to the first embodiment, it is possible to detect interference including interference caused by a CP length difference or a synchronization timing difference.

### Second Embodiment

In a second embodiment, stopping transmission in some of resources in which interference is detected will be described.

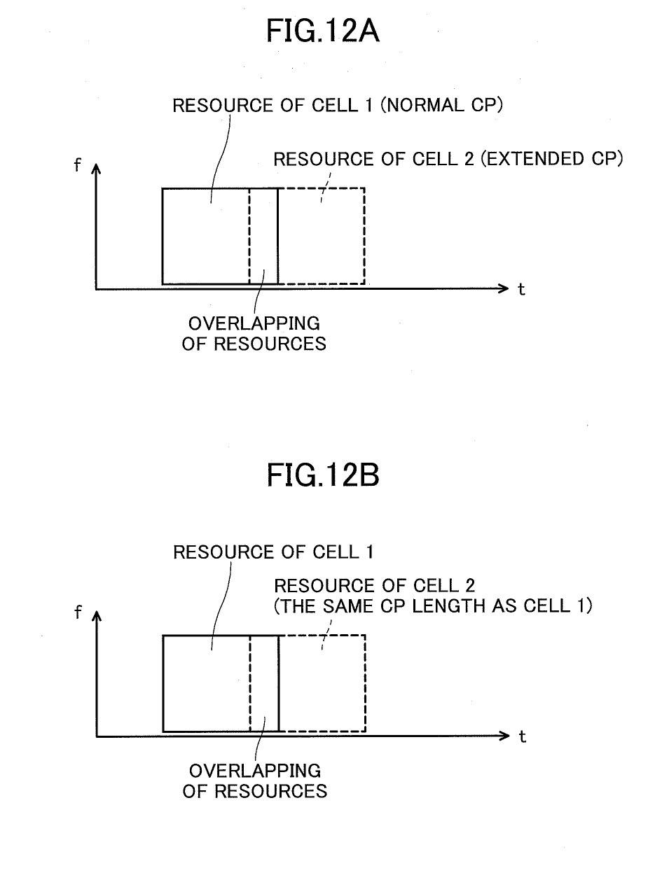

As described in the first embodiment, it is possible for the user apparatus UE to detect the interference type 1 (interference caused by a CP length difference) or the interference type 2 (interference caused by a synchronization timing difference), and to detect which allocated resources overlap a D2D signal. FIG. 12A and FIG. 12B are drawings illustrating overlapping of resources detected in a user apparatus according to an embodiment. For example, interference occurs by having some of resources of a cell 1 overlapping some of resources of a cell 2. Frequency resources may be the same or different.

In the case where the interference type 1 or the interference type 2 is detected as illustrated in FIG. 12A and FIG. 12B, the user apparatus UE may stop D2D signal transmission in the part where the resources are overlapped. As described above, it is possible for the interference detection unit 2038 of the user apparatus to detect in which resources the interference has occurred. The control unit 2031 may stop D2D signal transmission in the resources where the interference has been detected.

In the case where the user apparatuses UE1 and UE3 illustrated in FIG. 3 or FIG. 4 detect interference and stop D2D signal transmission, there is a possibility that the overlapped resources are not used and resource utilization efficiency is decreased. Therefore, the resource utilization efficiency may be increased by dividing the overlapped resources into a plurality of sub-resources in advance and setting usable sub-resources for each cell.

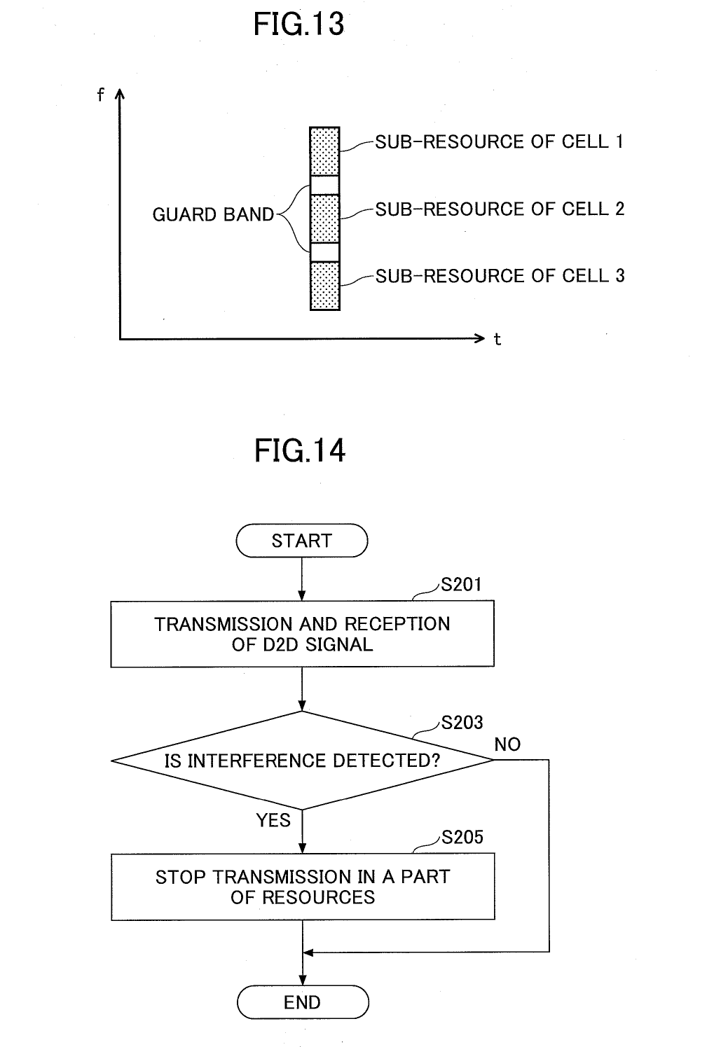

FIG. 13 is a drawing illustrating an example of an effective utilization of overlapped resources detected in a user apparatus according to an embodiment. In FIG. 13, overlapped resources of FIG. 12A or FIG. 12B are illustrated. The overlapped resources may be divided into a plurality of sub-resources on frequency axis (three sub-resources in FIG. 13). There may be guard bands between the sub-resources. In the case where interference is detected, the user apparatus UE1 of a cell 1 transmits a D2D signal via the sub-resource, of the divided sub-resources, usable in the cell 1 and stops D2D signal transmission via other sub-resources. Similarly, in the case where interference is detected, the user apparatus UE3 of a cell 2 transmits a D2D signal via the sub-resource usable in the cell 2 and stops D2D signal transmission via other sub-resources. It should be noted that the sub-resources usable in each cell may be associated with a serving cell by using a cell ID, a virtual cell ID, etc., including a sequence number (PSS NID) of a PSS (Primary Synchronization Channel) and a sequence number of SSS (Secondary Synchronization Channel) of the serving cell, etc.

FIG. 14 is a flowchart illustrating an interference avoiding method in a user apparatus according to a second embodiment.

The user apparatus 20 transmits a D2D signal generated in the transmission signal generation unit 2032 of the baseband signal processing unit 203 from the transmission and reception unit 205 and the amplifier 207. Further, the user apparatus 20 receives a D2D signal transmitted from other user apparatuses via the reception signal decoding unit 2034 (step S201).

The interference detection unit 2038 detects interference by, for example, failing signal reception in specific resources and determining whether the received energy in the resources is greater than a threshold value (step S203). Further, the interference detection unit 2038 may detect, from information of a transmission resource pool used by other cells, a possibility of occurrence of interference.

The control unit 2031 causes the transmission signal generation unit 2032 and the mapping unit 2033 to stop transmission of a D2D signal in the resources where the interference is detected (step S205). The control unit 2031 may stop the D2D signal transmission in at least a part of the resources where the interference is detected. For example, the control unit 2031 may stop D2D signal transmission in sub-resources associated with the serving cell.

As described above, according to the second embodiment, it is possible to avoid interference.

### Third Embodiment

In a third embodiment, reporting the interference result to the base station and re-allocating resources by the base station will be described.

As described in the first embodiment, it is possible for the user apparatus UE to detect an interference result caused by a CP length difference. In the third embodiment, in order to avoid interference caused by a CP length difference, the user apparatus UE reports the interference result to the base station. In the case where the interference result caused by a CP length difference is received from the user apparatus UE, the base station eNB avoids the interference by re-allocating the resources.

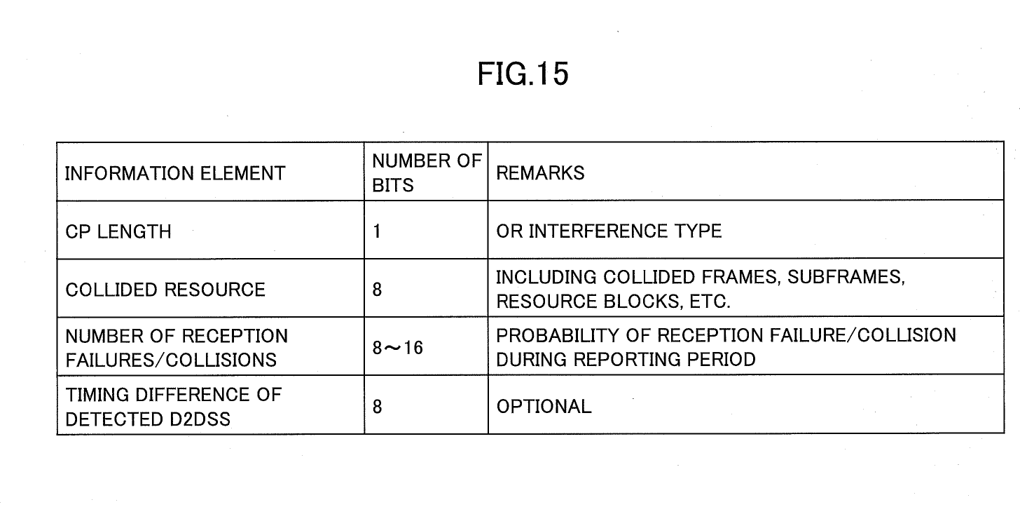

FIG. 15 is a drawing illustrating an example of reporting contents by the user apparatus UE according to an embodiment. In the case where interference is detected, the user apparatus UE may report to the base station the CP length, collided resources, the number of reception failures/collisions, a detected D2DSS timing difference, etc. The reporting may be performed by using a PUCCH or a PUSCH. The CP length is a CP length used by a user apparatus of a neighbor cell or out of coverage. Instead of the CP length, or in addition to the CP length, the interference type 1 or 2 may be reported. The collided resources may include frames, subframes, resource blocks, etc., where interference has occurred. The number of reception failures/collisions is information indicating the number of reception failures due to interference, and may be a probability of reception failure/collision during a predetermined reporting period. The detected D2DSS timing difference may be reported in order to synchronize the transmission and reception timing between cells. The reporting contents of the interference result may be used by the base station for allocating resources.

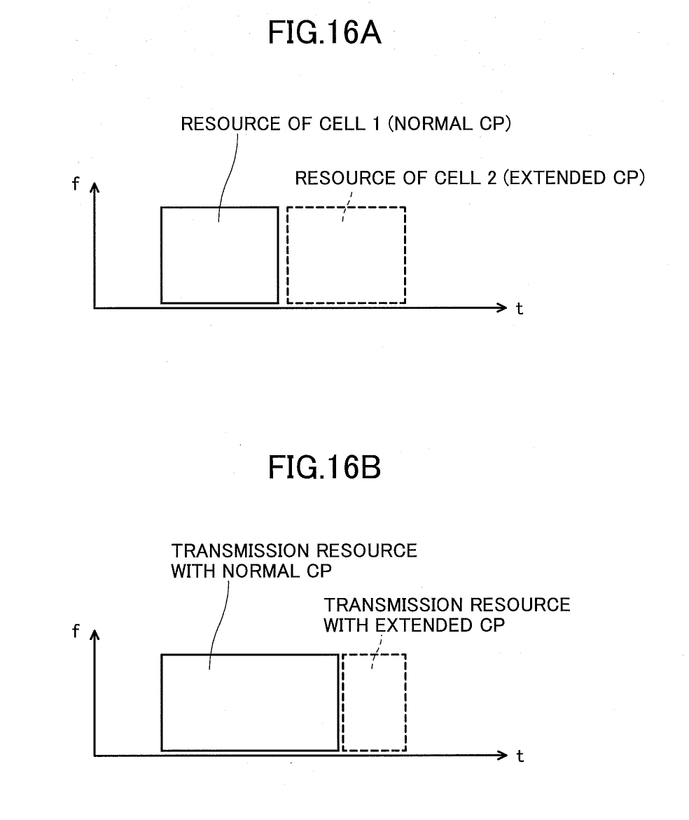

FIG. 16A and FIG. 16B are examples of resources allocated by the base station eNB according to an embodiment. As illustrated in FIG. 16A, the base station eNB may allocate resources which do not overlap with resources used by a neighbor cell to the user apparatus of own cell. For example, resources usable in a cell 1 are separated from resources usable in a cell 2 with respect to time. A user apparatus of the cell 1 transmits a D2D signal by using resources usable in the cell 1, and a user apparatus of the cell 2 transmits a D2D signal by using resources usable in the cell 2. By separating the resources as described above, it is possible to avoid interference even if the base station eNB1 of the cell 1 reports to use the normal CP and the base station eNB2 of the cell 2 reports to user the extended CP.

Alternatively, as illustrated in FIG. 16B, the base station eNB may divide the resources into resources usable by a user apparatus using the normal CP and resources usable by a user apparatus using the extended CP. In other words, the resources for which the normal CP is used in a neighbor cell are also used as resources for which the normal CP is used in the own cell, and the resources for which the extended CP is used in a neighbor cell are also used as resources for which the extended CP is used in the own cell. A user apparatus using the normal CP transmits a D2D signal by using resources usable by using the normal CP, and a user apparatus using the extended CP transmits a D2D signal by using resources usable by using the extended CP. It is possible to avoid interference caused by a CP length difference by dividing resources to be used based on the CP lengths.

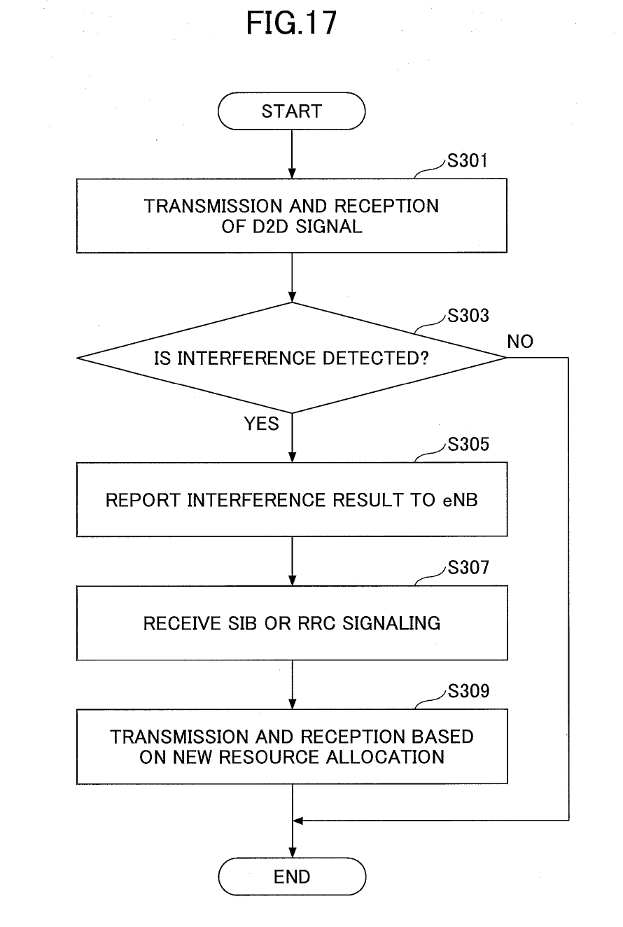

FIG. 17 is a flowchart illustrating an interference avoiding method in a user apparatus according to a third embodiment.

The user apparatus 20 transmits a D2D signal generated in the transmission signal generation unit 2032 of the baseband signal processing unit 203 via the transmission and reception unit 205 and the amplifier 207. Further, the user apparatus 20 receives a D2D signal transmitted from other user apparatuses via the reception signal decoding unit 2034 (step S301).

The interference detection unit 2038 detects interference by, for example, failing signal reception in specific resources and determining whether the received energy in the resources is greater than a threshold value (step S203). Further, the interference detection unit 2038 may detect, from information of a transmission resource pool used by other cells, a possibility of occurrence of interference. Further, the neighbor cell and out of coverage CP length detection unit 2037 may detect a CP length used by a user apparatus of a neighbor cell or out of coverage, and the interference detection unit 2038 may detect whether the interference is caused by a CP length difference or caused by a synchronization timing difference between cells.

An interference result detected by the interference detection unit 2038 is input to the control unit 2031, and the control unit 2031 causes the transmission signal generation unit 2032 to generate a signal for transmitting the interference result to the base station. The interference result is transmitted via the transmission and reception unit 205 and the amplifier 207 (step S305). The reception signal decoding unit 2034 receives information of resources set by the base station based on the interference result (step S307). The information of resources may be transmitted by upper layer signaling such as a system information block (SIB), RRC signaling, etc.

The control unit 2031 causes the mapping unit 2033 to map the D2D signal to the resources set by the base station (step S309). As a result, based on new resource allocation set by the base station, the D2D signal is transmitted and received.

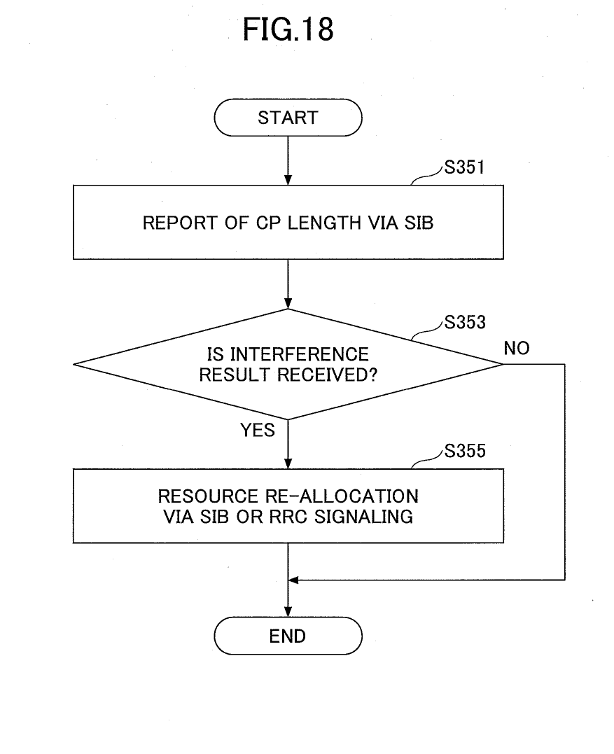

FIG. 18 is a flowchart illustrating an interference avoiding method in a base station according to the third embodiment. The control unit 1031 of the base station transmits the CP length to the user apparatus by using a system information block (SIB) (step S351).

When an interference result caused by a CP length difference is received from the user apparatus, the UL signal decoding unit 1035 of the base station inputs the interference result to the control unit 1031. Upon detecting the interference result from the user apparatus (step S353: YES), the control unit 1031 of the base station instructs the resource allocation unit 1034 to re-allocate resources. The resource allocation unit 1034 allocates resources which do not overlap with resources used by other cells to the user apparatus of own cell, and transmits the allocated resource information to the user apparatus via the DL signal generation unit 1032 and the mapping unit 1033. Alternatively, the resource allocation unit 1034 may divide the resources based on the CP lengths, and transmit the divided resource information to the user apparatus via the DL signal generation unit 1032 and the mapping unit 1033 (step S355). The set information of resources may be transmitted to the user apparatus by upper layer signaling such as a system information block (SIB), RRC signaling, etc.

As described above, according to the third embodiment, it is possible to avoid interference.

### Fourth Embodiment

In a fourth embodiment, reporting the CP length to a user apparatus out of coverage will be described.

As described by referring to FIG. 4, there is a case where interference is caused by receiving from a user apparatus out of coverage a D2D signal in which a different CP length is set. In order to avoid this type of interference, the CP length which is used by an in-coverage user apparatus is transmitted to an out-of-coverage user apparatus, and thus, it is possible to avoid interference caused by a CP length difference.

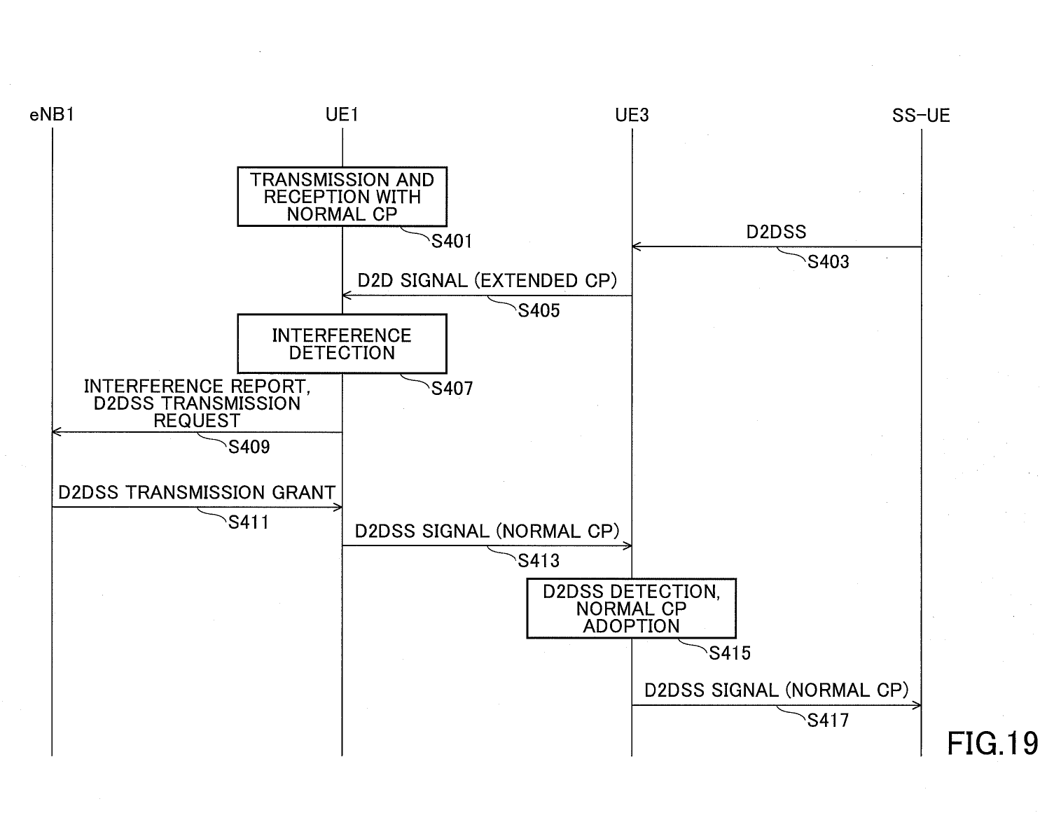

FIG. 19 is sequence diagram illustrating an interference avoiding method in a communication system according to the fourth embodiment. FIG. 19 illustrates a case in which interference is caused by causing an in-coverage user apparatus UE1 to use the normal CP reported by a SIB of the base station eNB1 of own cell, and causing an out-of-coverage user apparatus UE3 to use the extended CP reported by a user apparatus SS-UE transmitting a synchronization signal.

The in-coverage user apparatus UE1 transmits and receives a D2D signal by using the normal CP reported by the SIB of the base station eNB1 of own cell (step S401). On the other hand, the out-of-coverage user apparatus UE3 transmits a D2D signal by using the extended CP reported by D2DSS, etc., of the user apparatus SS-UE (steps S403 and S405).

The interference detection unit 2038 of the user apparatus 20 detects interference by, for example, failing signal reception in specific resources and determining whether the received energy in the resources is greater than a threshold value (step S407). Further, the interference detection unit 2038 may detect, from information of a transmission resource pool used by other cells, a possibility of occurrence of interference. Further, the neighbor cell and out of coverage CP length detection unit 2037 detects that a different CP length is used by the out-of-coverage user apparatus UE3.

In the case where interference with the out-of-coverage user apparatus UE3 caused by a CP length difference is detected by the interference detection unit 2038, the control unit 2031 of the user apparatus UE1 causes the transmission signal generation unit 2032 to generate a D2DSS transmission request for reporting the in-coverage CP length to the out-of-coverage user apparatus UE3. Further, an interference result detected by the interference detection unit 2038 is input to the control unit 2031, and the control unit 2031 may cause the transmission signal generation unit 2032 to generate a signal for transmitting the interference result to the base station eNB1. The D2DSS transmission request and the interference result are transmitted to the base station eNB1 via the transmission and reception unit 205 and the amplifier 207 (step S409).

In the case where a D2DSS transmission grant is received from the base station eNB1 (step S411), the control unit 2031 of the user apparatus UE1 causes the transmission signal generation unit 2032 to generate a D2DSS for reporting the in-coverage CP length (normal CP) to the out-of-coverage user apparatus UE3 (step S413). The D2DSS is transmitted to the user apparatus UE3, and the user apparatus UE3 which has detected the D2DSS adopts the in-coverage CP length (normal CP) (step S415). Further, the user apparatus UE3 may transmit a D2DSS for reporting the adopted CP length (normal CP) to another out-of-coverage user apparatus SS-UE (step S417).

As described above, according to the fourth embodiment, it is possible to avoid interference caused by a CP length difference also in the case where there is an out-of-coverage user apparatus.

### Effect of Embodiment

According to an embodiment of the present invention, it is possible to detect interference including the CP length difference, and to reduce or avoid the interference.

According to the first embodiment, it is possible to report the CP length to the user apparatus of a neighbor cell or out of coverage by using a D2DSS. D2DSS symbol positions are used for reporting the CP length, and thus, many resources are needed. However, it is not necessary to use multiple D2DSS sequences, and, it is possible to easily determine the CP length by only using D2DSS correlation based detection. Further, even in the case where the D2DSS CP length is different from the CP length of SA or a discovery signal, it is possible to determine the CP length. Further, it is possible to determine the CP length by processing D2DSS in the case where D2DSS parameters are used for reporting the CP length.

Further, a system information block (SIB) of a neighbor cell may be used for detecting the CP length between the in-coverage user apparatuses. It is possible for the user apparatus to determine the CP length by receiving a system information block (SIB) of a neighbor cell without detecting the D2DSS.

According to the second embodiment, when interference is detected, it is possible to stop D2D signal transmission according to the determination of the user apparatus, and thus, it is possible to avoid interference without increasing signaling load. On the other hand, stopping transmission decreases resource utilization efficiency. However, the resource utilization efficiency can be increased by dividing the overlapped resources into multiple sub-resources.

According to the third embodiment, it is possible to avoid interference and, at the same time, increase resource utilization efficiency by appropriate resource setting by the base station.

According to the fourth embodiment, it is possible to avoid interference with an out-of-coverage user apparatus caused by a CP length difference.

For the sake of description convenience, the base station and the user apparatus according to an embodiment have been described using functional block diagrams. The base station and the user apparatus may be implemented by hardware, by software, or by combination of both. Further, the functional units may be combined to be used as necessary. Further, a method according to an embodiment may be performed in the order different from the order illustrated in an embodiment.

As described above, methods have been described for detecting interference including a CP length difference, and reducing or avoiding the interference. The embodiments are not limited to the above, and various modifications and applications may be possible within the scope of claims.

The present PCT application is based on and claims the benefit of priority of Japanese Priority Application No. 2014-098134 filed on May 9, 2014, the entire contents of which are hereby incorporated by reference.

### DESCRIPTION OF THE REFERENCE NUMERALS

10 Base station
101 Transmission path interface
103 Baseband signal processing unit
105 Call processing unit
107 Transmission and reception unit
109 Amplifier
1031 Control unit
1032 Downlink (DL) signal generation unit
1033 Mapping unit
1034 Resource assignment unit
1035 Uplink (UL) signal decoding unit
1036 Determination unit
20 User apparatus
201 Application unit
203 Baseband signal processing unit
205 Transmission and reception unit
207 Amplifier
2031 Control unit
2032 Transmission signal generation unit
2033 Mapping unit
2034 Reception signal decoding unit
2035 Determination unit
2036 D2D synchronization signal detection unit
2037 Neighbor cell and out of coverage CP length detection unit
2038 Interference detection unit

1. A user apparatus comprising:
a cyclic prefix length detection unit configured to detect a cyclic prefix length used by a user apparatus of a neighbor cell or out of coverage; and
an interference detection unit configured to detect interference caused by a cyclic prefix length difference, a synchronization timing difference, or collision of resources used for signal transmission.

2. The user apparatus according to claim 1, wherein the cyclic prefix length detection unit detects the cyclic prefix length used by a user apparatus of a neighbor cell or out of coverage by using correlation based detection of a device to device synchronization signal D2DSS, D2DSS parameter detection, or reception of a system information block SIB of a neighbor cell.

3. The user apparatus according to claim 1, further comprising:
a control unit configured to, in the case where interference with the user apparatus of the neighbor cell is detected, stop transmission in at least a part of resources where the interference is detected.

4. The user apparatus according to claim 1, further comprising:
a transmission unit configured to transmit an interference result caused by a cyclic prefix length difference to a base station;
a reception unit configured to receive information of resources set by the base station based on the interference result; and
a mapping unit configured to map a signal to the resources set by the base station.

5. The user apparatus according to claim 1, further comprising:
a transmission unit configured to, in the case where interference with a user apparatus out of coverage caused by a cyclic prefix length difference is detected, transmit the cyclic prefix length of own cell to the user apparatus out of coverage.

6. An interference detection method in a user apparatus comprising:
detecting a cyclic prefix length used by a user apparatus of a neighbor cell or out of coverage; and
detecting interference caused by a cyclic prefix length difference, a synchronization timing difference, or collision of resources used for signal transmission.

7. A base station comprising:
a reception unit configured to receive from a user apparatus an interference result caused by a cyclic prefix length difference;
a resource allocation unit configured to set resources based on the received interference result; and
a transmission unit configured to transmit the set resource information to the user apparatus.

8. The base station according to claim 7, wherein the resource allocation unit allocates resources which do not overlap resources used by the neighbor cell to a user apparatus of own cell.

9. The base station according to claim 7, wherein the resource allocation unit divides the resources to be used based on the cyclic prefix length.

10. A resource allocation method in a base station comprising:
receiving from a user apparatus an interference result caused by a cyclic prefix length difference;
re-allocating resources based on the received interference result; and
transmitting set resource information to the user apparatus.

11. The user apparatus according to claim 2, further comprising:
a control unit configured to, in the case where interference with the user apparatus of the neighbor cell is detected, stop transmission in at least a part of resources where the interference is detected.

12. The user apparatus according to claim 2, further comprising:
a transmission unit configured to transmit an interference result caused by a cyclic prefix length difference to a base station;
a reception unit configured to receive information of resources set by the base station based on the interference result; and
a mapping unit configured to map a signal to the resources set by the base station.

13. The user apparatus according to claim 2, further comprising:
a transmission unit configured to, in the case where interference with a user apparatus out of coverage caused by a cyclic prefix length difference is detected, transmit the cyclic prefix length of own cell to the user apparatus out of coverage.

14. The user apparatus according to claim 3, further comprising:
a transmission unit configured to transmit an interference result caused by a cyclic prefix length difference to a base station;
a reception unit configured to receive information of resources set by the base station based on the interference result; and
a mapping unit configured to map a signal to the resources set by the base station.

15. The user apparatus according to claim 3, further comprising:
a transmission unit configured to, in the case where interference with a user apparatus out of coverage caused by a cyclic prefix length difference is detected, transmit the cyclic prefix length of own cell to the user apparatus out of coverage.

16. The user apparatus according to claim 4, further comprising:
a transmission unit configured to, in the case where interference with a user apparatus out of coverage caused by a cyclic prefix length difference is detected, transmit the cyclic prefix length of own cell to the user apparatus out of coverage.
